(19) United States
(12) Patent Application Publication
(10) Pub. No.: US 2018/0015604 A1
(43) Pub. Date: Jan. 18, 2018

(54) Folding Pocket Tool

(71) Applicant: True Brands Limited, Ringwood (GB)

(72) Inventor: Lee Berman, Bournemouth (GB)

(21) Appl. No.: 15/640,069

(22) Filed: Jun. 30, 2017

(30) Foreign Application Priority Data
Jul. 13, 2016 (GB) 1612125.3

(51) Int. Cl. B25F 1/04; A45C 11/32

(52) U.S. Cl. CPC B25F 1/04; A45C 11/324

(57) ABSTRACT

A pocket tool (e.g. a key carrier) comprises two tool elements such as a bottle-opener/screwdriver blade and a carabiner clip pivotally deployable on opposite sides of a central handle plate. A spring bar mounted on one face of the central handle plate has a free end portion which engages diametrically opposed flats formed on camming surfaces of root portions of the carabiner clip and bottle-opener/screwdriver blade respectively in order to hold them in their retracted and deployed positions. The free end portion includes a transverse projection which extends through a cut-out or aperture to enable it to engage the camming surface of the carabiner clip, enabling control of two tool elements on opposite sides of the central handle plate. When one tool element is held in the deployed configuration the other tool element is held in the retracted configuration.

### PRIORITY CLAIM

The present application claims priority to GB patent application number 1612125.3 filed in the United Kingdom on Jul. 13, 2016 entitled “Folding Pocket Tool” which is incorporated herein by reference in its entirety.

### TECHNICAL FIELD

The present invention relates to a folding pocket tool. The invention relates particularly but not exclusively to a pocket key carrier.

### BACKGROUND

Pocket tools are known in which pivotally deployable tool elements (e.g. knife blades) are each controlled by a respective spring bar having a free end which engages two flats formed in a generally cylindrical camming surface formed in a root portion of each tool element. The two flats are diametrically opposed and locate the tool element in the fully retracted and fully deployed positions respectively. Inadvertent opening or closing of a tool element (particularly a knife blade) is resisted because this will involve bending of the spring bar as it rides over one of the flats formed in the camming surface. In such known pocket tools, each tool element is provided with its own spring bar to enable independent deployment of multiple tool elements.

### SUMMARY

Aspects of the present invention provides a folding pocket tool comprising first and second tool elements mounted on opposite sides of a common mounting plate, each tool element being independently pivotally deployable about a common axis from a retracted configuration to a deployed configuration, a spring element being carried by the common mounting plate and having a free end portion which extends transversely between opposite sides of said common mounting plate, said free end portion resiliently engaging respective camming surfaces of said tool elements to locate each of said tool elements in at least one of said retracted and deployed configurations.

Thus two pivotally deployable tool elements on opposite sides of the handle plate can be controlled by one spring element (e.g. a leaf spring or spring bar). In one aspect, said spring element is mounted on one side of said common mounting plate and said free end portion includes a transverse projection which extends to the opposite side of said common mounting plate and engages the camming surface of a tool element on said opposite side. In certain embodiments said transverse projection extends through an aperture or cut-out formed in said common mounting plate.

In some aspects of the technology, said camming surfaces each have substantially diametrically opposed flats which locate their associated tool elements in the retracted and deployed configurations respectively, whereby said spring element can locate one of said tool elements in the deployed configuration while holding the other of said tool elements in the retracted configuration. In one aspect, said spring element is a cantilevered spring bar. Preferably said spring bar and one of said tool elements are retained against a face of said common mounting plate. This feature dispenses with the requirement to attach the spring bar to the mounting plate, and thereby simplifies manufacture.

In some aspects of the technology, said tool elements are retained against opposite faces of said common mounting plate by a retaining hinge comprising a male threaded element engaging a female threaded element.

### BRIEF DESCRIPTION OF THE DRAWINGS

Certain embodiments of the invention are described below, by way of example only, with reference to FIGS. 1 to 6 of the accompanying drawings, wherein:

FIG. 1 is a sketch perspective view from above left of a pocket tool in accordance with one aspect of the technology with a carabiner clip shown in a deployed (unfolded) configuration;

FIG. 2 is a similar sketch perspective view from above of the pocket tool of FIG. 1 with the carabiner clip shown in a retracted (folded) configuration;

FIG. 3 is a sketch perspective view from above right of the pocket tool of FIG. 1 with a bottle-opener/screwdriver blade shown in a deployed (unfolded) configuration;

FIG. 4 is an exploded view of the pocket tool of FIG. 1;

FIG. 5 is an enlarged partial elevation showing the engagement of a projecting pin of a spring bar with the camming surface of the carabiner clip; and

FIG. 6 is an exploded view of the pocket tool of FIG. 1 showing an array of pivotally deployable keys.

### DETAILED DESCRIPTION OF EXEMPLARY ASPECTS OF THE TECHNOLOGY

Although the following detailed description contains many specifics for the purpose of illustration, a person of ordinary skill in the art will appreciate that many variations and alterations to the following details can be made and are considered to be included herein. Accordingly, the following embodiments are set forth without any loss of generality to, and without imposing limitations upon, any claims set forth. It is also to be understood that the terminology used herein is for the purpose of describing particular embodiments only, and is not intended to be limiting. Unless defined otherwise, all technical and scientific terms used herein have the same meaning as commonly understood by one of ordinary skill in the art to which this disclosure belongs.

As used in this specification and the appended claims, the singular forms “a,” “an” and “the” include plural referents unless the context clearly dictates otherwise. Thus, for example, reference to “a line” includes a plurality of such lines.

In this disclosure, “comprises,” “comprising,” “containing” and “having” and the like can have the meaning ascribed to them in U.S. Patent law and can mean “includes,” “including,” and the like, and are generally interpreted to be open ended terms. The terms “consisting of” or “consists of” are closed terms, and include only the components, structures, steps, or the like specifically listed in conjunction with such terms, as well as that which is in accordance with U.S. Patent law. “Consisting essentially of” or “consists essentially of” have the meaning generally ascribed to them by U.S. Patent law. In particular, such terms are generally closed terms, with the exception of allowing inclusion of additional items, materials, components, steps, or elements, that do not materially affect the basic and novel characteristics or function of the item(s) used in connection therewith. For example, trace elements present in a composition, but not affecting the compositions nature or characteristics would be permissible if present under the “consisting essentially of” language, even though not expressly recited in a list of items following such terminology.

When using an open ended term, like “comprising” or “including,” in this specification it is understood that direct support should be afforded also to “consisting essentially of” language as well as “consisting of” language as if stated explicitly and vice versa.

The terms “first,” “second,” “third,” “fourth,” and the like in the description and in the claims, if any, are used for distinguishing between similar elements and not necessarily for describing a particular sequential or chronological order. It is to be understood that any terms so used are interchangeable under appropriate circumstances such that the embodiments described herein are, for example, capable of operation in sequences other than those illustrated or otherwise described herein. Similarly, if a method is described herein as comprising a series of steps, the order of such steps as presented herein is not necessarily the only order in which such steps may be performed, and certain of the stated steps may possibly be omitted and/or certain other steps not described herein may possibly be added to the method.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments described herein are, for example, capable of operation in other orientations than those illustrated or otherwise described herein. The term “coupled,” as used herein, is defined as directly or indirectly connected in an electrical or nonelectrical manner. Objects described herein as being “adjacent to” each other may be in physical contact with each other, in close proximity to each other, or in the same general region or area as each other, as appropriate for the context in which the phrase is used. Occurrences of the phrase “in one embodiment,” or “in one aspect,” herein do not necessarily all refer to the same embodiment or aspect.

Reference throughout this specification to “an example” means that a particular feature, structure, or characteristic described in connection with the example is included in at least one embodiment. Thus, appearances of the phrases “in an example” in various places throughout this specification are not necessarily all referring to the same embodiment.

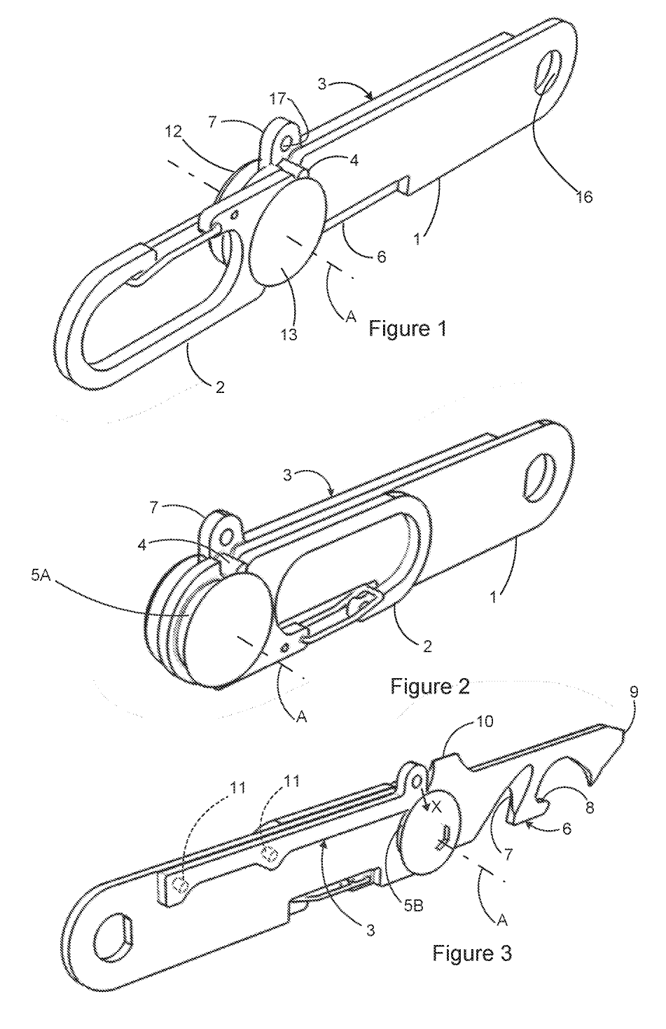

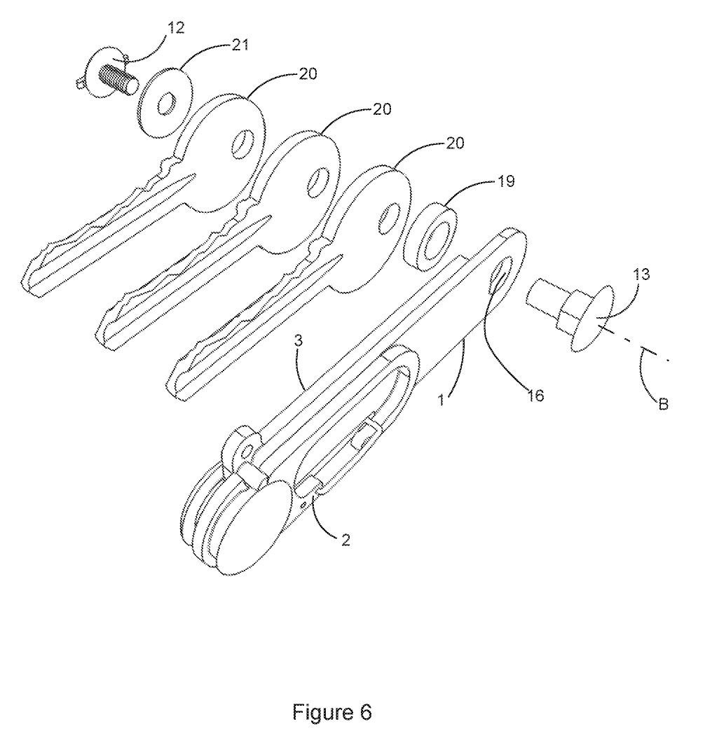

Referring to FIG. 1, a pocket key carrier is shown which comprises a stainless mounting plate 1 having a carabiner clip 2 pivotally mounted on the left hand side and a bottle-opener/screwdriver blade 6 (best seen in FIG. 3) pivotally mounted on the right hand side at its forward end, both these tool elements being retained by a hinge assembly 13, 12 for rotation about axis A. Mounting plate 1 serves as the handle of the tool. Carabiner clip 2 can be used to attach the carrier to a user's belt loop (not shown), enabling keys (shown as item 20 in FIG. 6, for example) to be carried by the user.

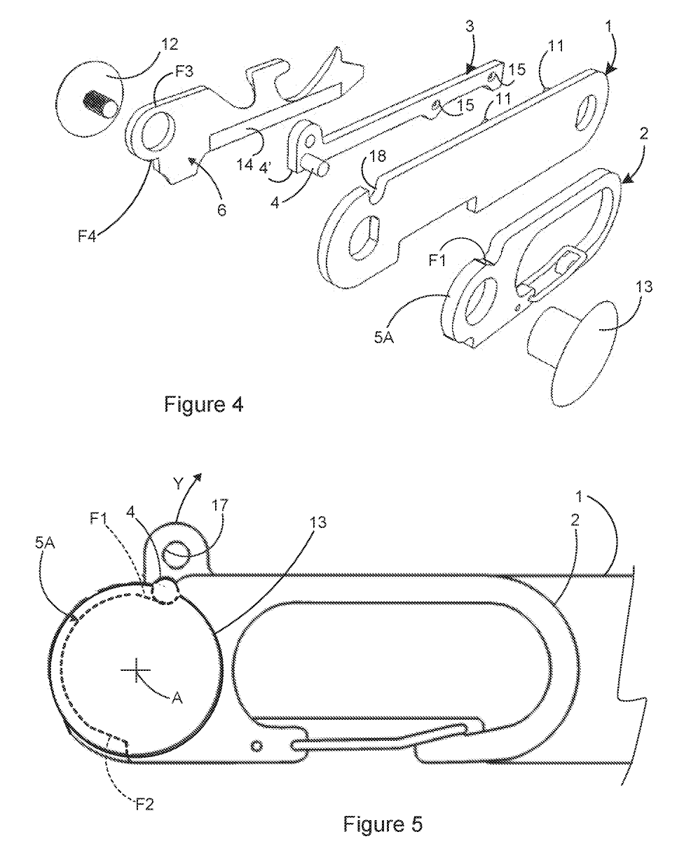

A spring bar 3 is detachably mounted on the right hand face of mounting plate 1 and has an upwardly-projecting eyelet portion 7 at its forward free end with an aperture 17 for attaching the tool to e.g. a key ring or a carrying loop or clip. A pin 4 projects laterally from the left hand side of eyelet portion 7 and extends through a generally V-shaped cut-out in the upper edge of mounting plate 1 to the left hand side of mounting plate 1 where it engages a camming surface formed in the root portion of carabiner clip 2. Generally, V-shaped cut-out 18 is seen, for example, in FIG. 4.

The mounting of spring bar 3 can be seen, for example, in FIG. 3, which shows two locating pins 11 extending from the right hand side of mounting plate 1 into registering apertures formed in the rear and mid-regions of the spring bar. The spring bar can be dismounted from these locating pins. In another aspect, the locating pins are integral with the spring bar and fit registering apertures in the mounting plate. In another aspect, the locating pins are rivets permanently securing the spring bar to the mounting plate. The spring bar is cantilevered to the mounting plate and exerts a downward force as indicated by arrow X when it rides over a flat formed in a camming surface 5B of bottle-opener/screwdriver blade 6 during retraction or deployment of the bottle-opener/screwdriver blade 6. Bottle-opener/screwdriver blade 6 includes a wire-cutter portion 7, bottle-opener portion 8, and forward and lateral screwdriver bits 9 and 10. As seen in FIG. 4, it also includes a nail file portion 14.

Referring to FIG. 4, the assembly is held together with a screwed hinge assembly of plastics material comprising male threaded hinge part 12 and female threaded hinge part 13. Camming surface 5B of bottle-opener/screwdriver blade 6 is shown with diametrically opposed flats F3 and F4. Flat F3 engages the underside portion 4′ of spring bar 3 when the bottle-opener/screwdriver blade 6 is retracted (folded configuration) and flat F4 engages the underside portion 4′ of spring bar 3 when the bottle-opener/screwdriver blade 6 is deployed (unfolded configuration). Apart from flats F3 and F4, camming surface 5B is cylindrical, with its axis coincident with axis A (see, e.g., FIG. 1).

Carabiner clip 2 has a camming surface 5A which, like camming surface 5B, is generally cylindrical with a cylinder axis coincident with axis A, but having diametrically opposed flats. One of these, namely F1 is shown in FIG. 4 and the other, F2, is seen in FIG. 5.

Referring generally to FIG. 5, pin 4 is shown engaging flat F1 in the retracted (folded) configuration of carabiner clip 2. Clockwise rotation of carabiner clip 2, to deploy the carabiner clip, is resiliently resisted by spring bar 3 whose forward free end is raised (as indicated by arrow Y) as pin 4 rides over flat F1. When the carabiner clip is fully deployed, the pin 4 engages flat F2. In either configuration of carabiner clip 2, either flat F3 or flat F4 can engage portion 4′ of spring bar 3 (see FIG. 4) according to whether the screwdriver/bottle opener 6 is retracted or deployed.

FIG. 6 shows a lateral array of Yale® type door keys 20 mounted on a screwed hinge assembly of plastics material comprising male threaded hinge part 12 and female threaded hinge part 13. A spacer 19 is located between handle plate 1 and the array of keys and a friction washer 21 (e.g. a fiber washer) is located between the hinge part 12 and the array of keys. Each key is independently deployable by rotation about axis B of the hinge assembly.

Although the described embodiment shows the camming surfaces of both tool elements 2 and 6 having two flats, this is not essential, for example, for one or both tool elements may have one flat only. Furthermore, more than one tool element can be mounted on either side of mounting plate 1 for deployment about hinge axis A. Optionally, additional tool elements (e.g. one or more knife blades) can be mounted elsewhere on mounting plate 1, e.g. at its rear end.

Of course, it is to be understood that the above-described arrangements are only illustrative of the application of the principles of the present invention. Numerous modifications and alternative arrangements may be devised by those skilled in the art without departing from the spirit and scope of the present invention and the appended claims are intended to cover such modifications and arrangements. Thus, while the present invention has been described above with particularity and detail in connection with what is presently deemed to be the most practical and preferred embodiments of the invention, it will be apparent to those of ordinary skill in the art that numerous modifications, including, but not limited to, variations in size, materials, shape, form, function and manner of operation, assembly and use may be made without departing from the principles and concepts set forth herein.

1. A folding pocket tool comprising;
first and second tool elements mounted on opposite sides of a common mounting plate, each tool element being independently pivotally deployable about a common axis from a retracted configuration to a deployed configuration; and
a spring element being carried by the common mounting plate and having a free end portion which extends transversely between opposite sides of said common mounting plate, said free end portion resiliently engaging respective camming surfaces of said tool elements to locate each of said tool elements in at least one of said retracted and deployed configurations.

2. The folding pocket tool according to claim 1, wherein said spring element is mounted on one side of said common mounting plate and said free end portion includes a transverse projection which extends to the opposite side of said common mounting plate and engages the camming surface of a tool element on said opposite side.

3. The folding pocket tool according to claim 2, wherein said transverse projection extends through an aperture or cut-out formed in said common mounting plate.

4. The folding pocket tool according to according to claim 1, wherein said camming surfaces each have substantially diametrically opposed flats which locate their associated tool elements in the retracted and deployed configurations respectively, whereby said spring element can locate one of said tool elements in the deployed configuration while holding the other of said tool elements in the retracted configuration.

5. The folding pocket tool according to claim 1, wherein said spring element is a cantilevered spring bar.

6. The folding pocket tool according to claim 5, wherein said spring bar and one of said tool elements are retained against a face of said common mounting plate.

7. The folding pocket tool according to claim 1, wherein said tool elements are retained against opposite faces of said common mounting plate by a retaining hinge comprising a male threaded element engaging a female threaded element.

8. The folding pocket tool according to claim 1, wherein one of said tool elements is a carabiner clip.

9. The folding pocket tool according to claim 1, wherein at least one of said tool elements has two or more tool bit portions.

10. The folding pocket tool according to claim 1, comprising a hinge assembly for carrying an array of pivotally-deployable keys, said hinge assembly having a hinge axis which is spaced apart from said common axis of said tool elements.
